(19) United States
(12) Patent Application Publication
(10) Pub. No.: US 2005/0106317 A1
(43) Pub. Date: May 19, 2005

(54) Method for preparing ink-jet recording material

(75) Inventor: Shigeki Shino, Tokyo (JP)

Correspondence Address: BIRCH STEWART KOLASCH & BIRCH, PO BOX 747, FALLS CHURCH, VA, 22040-0747, US

(73) Assignee: MITSUBISHI PAPER MILLS LIMITED.

(21) Appl. No.: 10/983,721

(22) Filed: Nov. 9, 2004

(30) Foreign Application Priority Data
Oct. 10, 2003 (JP) 2003-379240
Jul. 8, 2004 (JP) 2004-201492

(51) Int. Cl. B05D 1/12

(52) U.S. Cl. 427/180

(57) ABSTRACT

There is disclosed a method for preparing an ink-jet recording material comprising the steps of forming at least one porous layer containing silica fine particles with an average secondary particle size of 500 nm or less, and coating a coating solution for preparing an inorganic fine particles-containing layer so that a solid content of the coated inorganic fine particles became 0.33 g/m² or less on the porous layer.

### BACKGROUND OF THE INVENTION

1. Field of the Invention

The present invention relates to a method for preparing an ink-jet recording material, more specifically to a method for preparing an ink-jet recording material that is excellent in ink-absorption property and has excellent glossiness, without causing interference fringe and coating failure.

2. Background Art

An ink-jet recording method can be carried out without noise, with high speed printing so that it is employed as a terminal printer and has been rapidly spread in recent years. Also, multi-color recording can be easily carried out by using a plural number of ink nozzles, and multi-color ink-jet recording has been carried out by various kinds of ink-jet recording systems. In particular, utilization of an ink-jet printer which can form a complicated image rapidly and accurately has been attracted attention as a hard copy-forming device of image information such as letters, various kinds of drawings and photographs prepared by a computer. Moreover, due to rapid spread of a digital camera in recent years, a digital photographic image becomes familiar and an ink-jet printer having a mode or inks exclusively used for photography which can print out these images with an inexpensive ink-jet printer has widely and rapidly spread similarly.

In these photographic uses, high glossiness is required. As a means to heighten glossiness, it has been known a means of providing a colloidal silica layer on a porous ink-receptive layer. For example, it has been disclosed in Japanese Unexamined Patent Publications No. Hei. 6-183134, No. 2000-37944, No. 2000-62314, No. 2003-94800, Japanese Patent No. 3398475, and the like.

In the prior art technique as described above, a coated amount of a solid component of the colloidal silica layer has been set to be high (for example, 1 g/m² or more) to obtain high glossiness. By making a coated amount of the colloidal silica layer high, glossiness becomes high but it causes a low ink-absorption property.

Also, in the preparation method in which a colloidal silica layer, is applied after forming a porous ink-receptive layer, it has been newly found that interference fringe is easily caused.

Further, in the preparation method in which the porous ink-receptive layer and the colloidal silica layer which is a thin layer are coated with multi-layer simultaneously, disorder of a coated surface is likely caused, and glossiness and ink-absorption property are not sufficiently satisfied.

Moreover, when the porous ink-receptive layer is constituted by wet process silica having a large average secondary particle size (for example, exceeding 500 nm), glossiness was completely insufficient.

Furthermore, the porous ink-receptive layer is constituted by alumina or alumina hydrate, it is not satisfied in view of ink-absorption capacity or glossiness.

Also, in the preparation method using a cast coating method in which a colloidal silica layer is dried by putting a cast drum, it causes disorder of the colloidal silica layer whereby minute unevenness occurs based on the difference in ink-absorption rate so that it was insufficient for photographic use. Also, it uses a cast drum so that it is not satisfied in the point of production efficiency. Moreover, the cast system involves the problem that a non-water absorptive support cannot be applied thereto.

### SUMMARY OF THE INVENTION

An object of the present invention is to provide a method for preparing an ink-jet recording material which has extremely high glossiness, excellent in ink-absorption property without causing surface interference fringe and coating failure.

An object of the present invention mentioned above can be accomplished by a method for preparing an ink-jet recording material, which comprises forming at least one porous layer containing silica fine particles having an average secondary particle size of 500 nm or less on a support, and applying a coating solution for forming an inorganic fine particles-containing layer on the porous layer so that a coated amount of a solid component of the inorganic fine particles is 0.33 g/m² or less.

### DESCRIPTION OF THE PREFERRED EMBODIMENTS

One of the characteristic features of the present invention resides in that a liquid portion (mainly water) of the coating solution for preparing an inorganic fine particles-containing layer is instantaneously absorbed in the porous layer, whereby the inorganic fine particles are fixed on the surface of the porous layer, so that a uniform layer is formed, and as a result, high glossiness can be obtained. Further, by making the inorganic fine particles-containing layer a thin layer, high ink-absorption property can be obtained without causing interference fringe.

That is, a recording material which is excellent in glossiness and ink-absorption property and causing no interfereence fringe, which is an object of the present invention, can be realized by coating an inorganic fine particles-containing layer with a thin layer after forming the porous layer. Here, a timing of forming the porous layer is a time of a stage in the course of drying after coating a coating solution (a solution containing silica fine particles having an average secondary particle size of 500 nm or less) for forming the porous layer on a support or a time after completion of drying, at which sufficient amount of voids is formed in the porous layer.

Accordingly, the timing of coating the coating solution for forming the inorganic fine particles-containing layer is in the course of the drying after coating the coating solution for forming the porous layer, or the time of after completion of the drying.

In the present invention, a coated amount of the solid component of the inorganic fine particles-containing layer is 0.33 g/m² or less in terms of the weight of the inorganic fine particles. A preferred coated amount of the solid component of the inorganic fine particles is 0.25 g/m² or less, more preferably 0.17 g/m² or less, further preferably 0.1 g/m² or less. A lower limit of the coated amount is about 0.01 g/m² or so in view of obtaining high glossiness.

To develop an interference action of light means that the inorganic fine particles-containing layer and the porous layer can be optically identified to each other, in other words, there are difference in refractive index. That is, it means that there is an interface between the inorganic fine particles-containing layer and the porous layer.

When the porous layer and the inorganic fine particles-containing layer are simultaneously multi-layer coated, no clear interface can be formed so that no interference fringe occurs. However, high glossiness which is an object of the present invention cannot be obtained by the simultaneous multi-layer coating.

On the other hand, as in the present invention, when the inorganic fine particles-containing layer is coated after forming the porous layer (during the drying step after coating the porous layer; during drying or after completion of drying), an interface is formed between the two layers, and light is reflected at the interface so that glossiness improved, whereby interference fringe at a visible light region is also likely generated.

In the present invention, it can be found that occurrence of interference fringe can be prevented by making the inorganic fine particles-containing layer formed on the porous layer an extremely thin layer.

In the present invention, a coated amount of the inorganic fine particles-containing layer is 0.33 g/m² or less in terms of the inorganic fine particles. When a dried film thickness of the inorganic fine particles-containing layer is calculated from the above-mentioned coated amount of the solid component of the inorganic fine particles, it is about 200 nm or less. It is supposed that spherical inorganic fine particles such as colloidal silica are packed as the closest packing (packing: 74% by volume), a dried film thickness of the inorganic fine particles-containing layer can be calculated by dividing a coated amount of the solid component of the inorganic fine particles by the true density (a density obtained by using only a volume occupied by a substance itself as a volume for calculating the density) (colloidal silica; silicon dioxide, 2.2 g/cm³) of the inorganic fine particles, and further dividing the resulting value by 0.74.

As mentioned above, by making the dried film thickness of the inorganic fine particles-containing layer as thin as possible, an ink-jet recording material which has high glossiness but no occurrence of interference fringe, and has high ink-absorption property can be obtained.

The dried film thickness of the inorganic fine particles-containing layer calculated as mentioned above is preferably about 200 nm or less, more preferably about 150 nm or less, and further preferably about 100 nm or less. The lower limit thereof is about 10 nm or so, and preferably 20 nm or so.

In the preferred embodiment of the present invention, a coating amount of wet components of the coating solution for the inorganic fine particles-containing layer is set to be 90% by volume or less of the void volume of the porous layer. According to this, water component in the coating solution for the inorganic fine particles-containing layer is instantaneously absorbed in the porous layer, so that it is advantageous in the points of glossiness and uniformity of the coated surface. A lower limit of the coating amount of wet components of the coating solution for the inorganic fine particles-containing layer is preferably about 5 ml/m² in the viewpoint of stability for coating. Here, the void volume of the porous layer means a void volume at the time of providing the inorganic fine particles-containing layer. The void volume of the porous layer is preferably in the range of 15 to 50 ml/m² in the viewpoint of an ink-absorption property.

In the present invention, when the void volume of the porous layer is in the range of not more than 40 ml/m², the coating amount of wet components of the inorganic fine particles-containing layer is preferably 90% by volume or less of the void volume, more preferably 80% by volume or less of the same. When the void volume is in the range of 40 to 50 ml/m², the coating amount of wet components of the inorganic fine particles-containing layer is preferably 80% by volume or less of the void volume, more preferably 65% by volume or less of the same.

A void volume (void volume after completion of drying) of the porous layer can be measured by using a mercury porosimeter (for example, Autopore II 9220; manufactured by Micro Meritics Instrument Corporation). More specifically, it can be obtained as a numerical value per a unit surface area (m² ) by multiplying an integrated fine pore volume (ml/g) from a fine pore diameter of from 3 nm to 400 nm at the porous layer portion measured and treated by the mercury porosimeter by a coated solid component (g/m²) of the porous layer.

The void volume of the porous layer in the course of drying can be obtained by measuring a remaining water content at a predetermined position (immediately before coating the inorganic fine particles-containing layer) of the porous layer in the course of the drying step by an infrared moisture meter, etc., and subtracting the remaining water content from the above-mentioned void volume after completion of drying.

As a coating system to be used for coating the porous layer and the inorganic fine particles-containing layer, any of the conventionally known coating system can be used. For example, there are a slide bead system, a curtain system, an extrusion system, a slot system, a gravure rollers system, an air knife system, a blade coating system, a rod bar coating system and the like.

These coating methods can be roughly classified into a pre-metered coating method and a self-metered coating method. The pre-metered coating method is a method in which a coating solution an amount of which is previously metered so that it becomes a predetermined coating amount is coated. The self-metered coating method is a coating system in which it is excessively coated than a predetermined coating amount and an excessive material is scraped off at a later stage so that it becomes the predetermined coating amount.

As the pre-metered coating methods, there are a slide bead system, a curtain system, an extrusion system, a slot system, a gravure rollers system and the like, and the self-metered coating methods, there are an air knife system, a blade coating system, a rod bar coating system and the like.

In the preferred embodiment of the present invention, for coating the coating solution of the inorganic fine particles-containing layer, the pre-metered coating method is preferably employed. By using the pre-metered coating method, the inorganic fine particles-containing layer with an extremely thin layer can be coated on the porous layer stably.

As a coating device to be used for the above-mentioned pre-metered coating method, there may be mentioned a coating device which has a slit(s) for flowing the coating solution to a width direction such as a slide hopper, a slot die, etc., and a coating device using gravure rollers, and the like.

Even if the gravure rollers are employed, when lattice type gravure rollers as disclosed in Example of Japanese Patent No. 3398474 are employed, stitch pattern of the gravure remained on the surface, so that it is not advantageous for photographic use. As the gravure rollers, helical grooves gravure rollers (gravure rollers having helical grooves) having a roll diameter of 100 mm or less are preferably used. Preferred range of a diameter of the rolls is 20 to 80 mm or so.

When the helical grooves gravure rollers are used, it is preferably used as reverse with kiss touch. Here, the term “reverse” means that the gravure rollers are rotated to the direction reverse to a transporting direction of a web (a support on which the porous layer is coated), and the terms “kiss touch” means that the web is in a free state, in which no back up roller is present at one side of the web opposed to that of the gravure rollers.

Coating of the inorganic fine particles-containing layer may be separately carried out after coating the porous layer, drying the same and once the coated material was wound up, but it is preferred in the point of production efficiency to carry out coating of the porous layer, drying the same and winding up on the same line continuously. That is, it is preferred that the inorganic fine particles-containing layer is continuously coated and dried during the drying procedure of the porous layer.

A viscosity of the coating solution for the inorganic fine particles-containing layer at 35° C. is preferably 10 mPa.s or less, more preferably 5 mPa.s or less, particularly preferably in the range of 1 to 3 mPa.s.

By making the viscosity of the coating solution low, the coating solution is instantaneously absorbed in the porous layer, so that a uniform coated surface with high glossiness can be easily obtained.

In the present invention, as inorganic fine particles to be used in the inorganic fine particles-containing layer, colloidal silica or inorganic fine particles having a refractive index of 1.6 or more are preferably used.

A particle size of the inorganic fine particles is preferably an average primary particle size of 80 nm or less, more preferably 60 nm or less, further preferably in the range of 5 to 50 nm. Also, when the primary particles form a secondary particle in which a plural number of the primary particles are bonded, its average secondary particle size is preferably 200 nm or less, more preferably 150 nm or less, further preferably 100 nm or less.

Among the above-mentioned colloidal silica, an extremely monodispersed colloidal silica having an average primary particle size 80 nm or less and a variation coefficient of 0.15 or less is preferably employed.

The variation coefficient herein mentioned means that a value in which the standard deviation of the particle size of the colloidal silica particles are divided by an average diameter. The variation coefficient is a value calculated from an average diameter and a standard deviation obtained by measuring a diameter of 500 or more of colloidal silica particles randomly selected from an electron microscope of the colloidal silica particles.

By using the colloidal silica having a variation coefficient of 0.15 or less, the so-called printing portion haze in which a printed surface looks like slightly turbid when it is observed with slant light can be prevented.

An average primary particle size of the colloidal silica is preferably 80 nm or less, more preferably 60 nm or less. Most preferred range is from 10 nm to 50 nm.

Colloidal silica can be available as a commercially available product. For example, there is SNOWTEX available from Nissan Chemical Industries, Ltd. In colloidal silica, there are various kinds of colloidal silica of a type in which silica sol is subjected to grain growth under weak alkaline conditions and used as such, a type in which an alkali amount is decreased by ion-exchange, a type in which anionic property is strengthened by replacing a part of silicon atom in the lattice with aluminum atom, a type in which it is made cationic by surface treatment with alumina, and the like, and either of them can be used. Silica is slightly dissolved in an alkali so that it can be considered that it is advantageous to remain an alkali on the surface thereof in the point of adhesive force. However, a type in which ion-exchange is carried out may be also used without any problem.

The monodispersed colloidal silica having a variation coefficient of 0.15 or less can be prepared, for example, by the so-called sol-gel method in which alkoxysilane is hydrolyzed by using ammonia in an aqueous solvent and condensed. For example, various kinds of colloidal silica can be commercially available as QUARTRON series available from Fuso Chemical Co., Ltd.

It is one of the preferred embodiments that inorganic fine particles having a refractive index of 1.6 or more are used as the inorganic fine particles of the inorganic fine particles-containing layer.

As the inorganic fine particles having a relatively high refractive index 1.6 or more, there may be mentioned, for example, calcined clay (refractive index: 1.60), barium sulfate (refractive index: 1.63), magnesium oxides (refractive index: 1.64 to 1.74), rutile titanium oxide (refractive index: 2.76), anatase titanium dioxide (refractive index: 2.52), zinc oxide (refractive index: 2.0), zinc sulfide (refractive index: 2.4), white lead (refractive index: 2.0), calcined kaolin (refractive index: 1.62),antimony oxides (refractive index: 2.09 to 2.29), lead titanate (refractive index: 2.70), potassium titanate (refractive index: 2.68), zirconium oxide (refractive index: 2.40), cerium oxide (refractive index: 2.2), hafnium oxide (refractive index: 1.95), tantalum pentoxide (refractive index: 2.1), yttrium oxide (refractive index: 1.87), chromium oxide (refractive index: 2.5), tin oxide, ATO, ITO and the like, and they can be used singly or in combination of two or more in admixture. A complex oxide of these oxides or a complex sulfide of these sulfides can be widely used. Also, in the case of inorganic fine particles having photocatalytic activity such as titanium oxide, zinc oxide, etc., it is preferred that the surface of the inorganic fine particles is coated by silica, alumina, boron, etc., with an extremely thin layer. In this case, the refractive index can be obtained by calculating from a volume % of a substance coated on the surface.

In the present invention, the coating solution for preparing the inorganic fine particles-containing layer comprises the above-mentioned inorganic fine particles as a main component. This coating solution is sufficient as a simple aqueous solution prepared by diluting a slurry in which the inorganic fine particles are dispersed in a colloidal state with water and regulating a concentration thereof. However, for respective applications, it is possible to optionally add a binder, an additive, and the like. When the binder is added, a suitable amount thereof is preferably not more than 10% by weight, more preferably not more than 5% by weight, further preferably not more than 3% by weight based on the amount of the inorganic fine particles. In the point of ink-absorption property, an amount of the binder is preferably as little as possible. With regard to a surfactant, when it has a role of a coating aid, it is not necessary to add the surfactant to the coating solution and the coating solution can be coated as such. Addition of a component such as a matting agent, which markedly changes surface shapel, is not preferred in the points of accomplishing the objects of the present invention and improvement in glossiness.

A concentration of the inorganic fine particles in the coating solution for forming the inorganic fine particles-containing layer is preferably in the range of 0.05 to 5% by weight, more preferably in the range of 0.1 to 3% by weight, particularly preferably in the range of 0.25 to 2% by weight.

Next, the porous layer of the present invention is explained. The porous layer is required to have an excellent ink-absorption capacity as an ink-receptive layer, and to have an ability of instantaneously absorbing a liquid portion of the coating solution for forming the inorganic fine particles-containing layer coated thereon. Also, even when a thin layer of the above-mentioned inorganic fine particles-containing layer is provided, high glossiness cannot be obtained so that silica fine particles having an average secondary particle size of 500 nm or less is required to be contained in the porous layer.

The porous layer of the present invention is a void type ink-receptive layer, and a sufficient amount of void volume is preferably possessed therein. As the inorganic fine particles to be used for such a void type ink-receptive layer, it has been known to use amorphous synthetic silica such as wet process silica and fumed silica, and aluminum oxide such as alumina and alumina hydrate, and alumina or alumina hydrate has a high refractive index, so that a difference in average refractive indexes between the porous layer and the inorganic fine particles-containing layer is small whereby remarkable effect of improving glossiness cannot be obtained. Also, in the point of an ink-absorption capacity, silica is more preferred than aluminum oxide.

Also, when the wet process silica is used as such without effecting fine pulverization, glossiness becomes quite poor.

In amorphous synthesized silica, they can be roughly classified into wet process silica, fumed silica, and others according to the preparation processes. The wet process silica can be further classified into a precipitation method silica, a gel method silica and a sol method silica according to the preparation processes. The precipitation method silica can be prepared by reacting sodium silicate and sulfuric acid under alkali conditions, silica particles grown in particle size aggregated and precipitated, and then, they are processed through filtration, washing, drying, pulverization and classification to prepare a product. As the precipitation method silica, it is commercially available from TOSOH SILICA CORPORATION (Japan) under trade name of Nipsil, K.K. Tokuyama (Japan) under trade name of Tokusil. The gel method silica can be produced by reacting sodium silicate and sulfuric acid under acidic conditions. In this method, small silica particles are dissolved during ripening and so reprecipitated between other primary particles which are larger sized particles that primary particles are combined to each other. Thus, clear primary particles disappear and form relatively hard agglomerated particles having an inner void structure. For example, it is commercially available from TOSOH SILICA CORPORATION (Japan) under trade name of Nipgel, Grace Japan Co., Ltd. (Japan) under trade names of Syloid, Sylojet, and the like. The sol method silica is also called to as colloidal silica and can be obtained by heating and ripening silica sol obtained by methathesis of sodium silicate by an acid, etc., or passing through an ion-exchange resin layer, and is commercially available from Nissan Chemical Industries, Ltd. (Japan) under trade name of SNOWTEX.

Fumed silica is also called to as the drying method silica relative to the wet process method, and it can be generally prepared by a flame hydrolysis method. More specifically, it has generally been known a method in which silicon tetrachloride is burned with hydrogen and oxygen, and a silane such as methyl trichlorosilane or trichlorosilane may be used singly in place of silicon tetrachloride or as a mixture in combination with silicon tetrachloride. The fumed silica is commercially available from Nippon Aerosil K.K. (Japan) under the trade name of Aerosil, and K.K. Tokuyama (Japan) under the trade name of QS type, etc.

In the porous layer of the present invention, fumed silica or finely pulverized wet process silica, or a mixture thereof is preferably used. Of the silica, fumed silica is particularly preferred. In the silica fine particles of the porous layer of the present invention, colloidal silica to be used for the inorganic fine particles-containing layer is not included.

An average particle size of a primary particle of the fumed silica to be used in the porous layer of the present invention is preferably 30 nm or less, and more preferably 15 nm or less to obtain higher glossiness. More preferred are those having an average primary particle size of 3 to 15 nm, and having a specific surface area measured by the. BET method of 200 m²/g or more. Incidentally, the average primary particle size mentioned in the present specification is obtained from an observation by an electron micro-scope, and for each of 100 particles existing in a pre-determined area, a diameter of a circle whose area is equivalent to a projected area of each particle is taken as a particle diameter for that particle. The BET method mentioned in the present specification means one of methods for measuring a surface area of powder material by a gas phase adsorption method and is a method for obtaining a total surface area possessed by 1 g of a sample, i.e., a specific surface area, from an adsorption isotherm. In general, as an adsorption gas, a nitrogen gas has frequently been used, and a method of measuring an adsorption amount obtained by the change in pressure or a volume of a gas to be adsorbed has most frequently been used. Most famous equation for representing isotherm of polymolecular adsorption is a Brunauer-Emmett-Teller equation which is also called to as a BET equation and has widely been used for determining a surface area of a substance to be examined. A surface area can be obtained by measuring an adsorption amount based on the BET equation and multiplying the amount with a surface area occupied by the surface of one adsorbed molecule.

The fumed silica is preferably dispersed in the presence of a cationic compound. An average secondary particle size of the dispersed fumed silica is 500 nm or less, preferably 10 to 300 nm, more preferably 20 to 200 nm. As the dispersing method, it is preferred that fumed silica and a dispersing medium are provisionally mixed by a usual propeller stirring, turbine type stirring, homomixer type stirring, etc., and then, dispersion is carried out by using a media mill such as a ball mill, a bead mill, a sand grinder, etc., a pressure type dispersing device such as a high-pressure homogenizer, an ultra high-pressure homogenizer, etc., an ultrasonic wave dispersing device, and a thin-film spin type dispersing device, etc. The average secondary particle size of the silica fine particles mentioned in the present specification is a value obtained by observing the resulting porous layer with an electron microscope.

In the present invention, a wet process silica pulverized to an average secondary particle size of 500 nm or less is also preferably used. The wet process silica to be used in the present invention is silica particles preferably having an average primary particle size of 50 nm or less, more preferably 3 to 40 nm, and an average agglomerated particle size (that is a particle size before pulverization) of 5 to 50 μm. In the present invention, preferably used are those in which these wet process silica are finely pulverized in the presence of a cationic compound to have an average secondary particle size of 500 nm or less, preferably about 20 to 200 nm.

Since the wet process silica produced by the conventional method has an average agglomerated particle size of 1 μm or more, this is used after finely pulverized. As the pulverization method, a wet pulverization method in which silica dispersed in an aqueous medium is mechanically pulverized is preferably used. At this time, it is preferred to use a precipitation method silica having an oil absorption amount of 210 ml/100 g or less and an average agglomerated particle size of 5 μm or more since increase in initial viscosity of the dispersion is controlled, dispersion with high solid concentration is realized and the particles can be pulverized finer due to increase in pulverization and dispersion efficiencies. By using a dispersion with a higher solid concentration, productivity of the recording paper is also improved. The oil absorption amount can be measured according to the description of JIS K-5101.

As a specific method to prepare wet process silica fine particles having an average secondary particle size of 500 nm or less of the present invention, there may be mentioned, for example, a method of mixing silica particles and a cationic compound in water (addition of the materials may be carried out either of which firstly or may be simultaneously carried out), a method of mixing respective dispersions or aqueous solutions, and then, mixing the liquid by using at least one of a saw blade type dispersing device, a propeller blade type dispersing device, and a rotor stator type dispersing device to prepare a provisional dispersion. If necessary, a suitable amount of a low boiling point solvent, etc., may be further added to the dispersion. A solid concentration of the silica provisional dispersion is preferably as high as possible, but it is too high concentration, dispersion becomes impossible, so that the solid concentration is preferably in the range of 15 to 40% by weight, more preferably 20 to 35% by weight. Next, the silica provisional dispersion obtained by the above-mentioned method is further dispersed by using a more potent mechanical means to prepare a wet process silica fine particle dispersion having an average secondary particle size of 500 nm or less. As the mechanical means, those conventionally known in the art can be employed, and there may be used, for example, a media mill such as a ball mill, a bead mill, a sand grinder, etc., a pressure type dispersing device such as a high-pressure homogenizer, an ultra high-pressure homogenizer, etc., an ultrasonic wave dispersing device, and a thin-film spin type dispersing device, etc.

As the cationic compound to be used for dispersing the above-mentioned fumed silica and the wet process silica, a cationic polymer or a water-soluble metallic compound may be used. As the cationic polymer, there may be preferably mentioned polyethyleneimine, polydiallylamine, polyallylamine, polyalkylamine, as well as polymers having a primary to tertiary amino group or a quaternary ammonium group as disclosed in Japanese Unexamined Patent Publications No. Sho. 59-20696, No. Sho. 59-33176, No. Sho. 59-33177, No. Sho. 59-155088, No. Sho. 60-11389, No. Sho. 60-49990, No. Sho. 60-83882, No. Sho. 60-109894, No. Sho. 62-198493, No. Sho. 63-49478, No. Sho. 63-115780, No. Sho. 63-280681, No. Hei. 1-40371, No. Hei. 6-234268, No. Hei. 7-125411 and No. Hei. 10-193776, etc. In particular, a diallylamine derivative is preferably used as the cationic polymer. An average molecular weight (Mw; weight average molecular weight) of these cationic polymers is preferably 2,000 to 100,000, particularly preferably in the range of 2,000 to 30,000 in the points of dispersibility and a viscosity of the dispersion.

As the water-soluble metallic compound, there may be mentioned, for example, a water-soluble polyvalent metallic salt. Of these, a compound comprising aluminum or a metal of Group 4A (Group 4) of the Periodic Table (for example, zirconium, titanium) is preferably used. A water-soluble aluminum compound is particularly preferably used. The water-soluble aluminum compound may include, for example, aluminum chloride and its hydrate, aluminum sulfate and its hydrate, aluminum alum, etc. as an inorganic salt thereof. Moreover, it has been known a basic poly(aluminum hydroxide) compound which is an inorganic aluminum-containing cationic polymer, and it is preferably used.

The above-mentioned basic poly(aluminum hydroxide) compound is a water-soluble poly(aluminum hydroxide) a main component of which is represented by the following formula (1), (2) or (3), and which contains a polynuclear condensed ion which is basic and a polymer in a stable form, such as [Al₆(OH)₁₅]³⁺, [Al₈(OH)₂₀]⁴⁺, [Al₁₃(OH)₃₄]⁵⁺, [Al₂₁(OH)₆₀]³⁺, etc.
[Al₂(OH)ₙCl₆₋ₙ]ₘ (1)
[Al(OH)₃]ₙAlCl₃ (2)
Alₙ(OH)ₘCl₍₃ₙ₋ₘ₎0<m<3n (3)

These materials are commercially available from Taki Chemical, K.K. (Japan) under the trade name of poly-(aluminum chloride) (PAC) as a water treatment agent, from Asada Chemical K.K. (Japan) under the trade name of poly-(aluminum hydroxide) (Paho), from K.K. Riken Green (Japan) under the trade name of Pyurakemu WT and other manufacturers with the same objects whereby various kinds of different grades can be easily obtained.

The water-soluble compound containing an element of Group 4 of the Periodic Table to be used in the present invention is more preferably a water-soluble compound containing titanium or zirconium. As the water-soluble compound containing titanium, there may be mentioned titanium chloride and titanium sulfate. As the water-soluble compound containing zirconium, there may be mentioned zirconium acetate, zirconium chloride, zirconium oxychloride, zirconium hydroxychloride, zirconium nitrate, basic zirconium carbonate, zirconium hydroxide, zirconium lactate, ammonium zirconium carbonate, potassium zirconium carbonate, zirconium sulfate, zirconium fluoride, and the like. In the present invention, the term “water-soluble” means that the compound is dissolved in water in an amount of 1% by weight or more at normal temperature under normal pressure.

In the porous layer of the present invention, fumed silica and finely pulverized wet process silica can be used each alone, or as a mixture thereof. When both of them are used in admixture, a mixing ratio is preferably in the range of 30:70 to 70:30 in terms of a weight ratio. Also, other inorganic or organic fine particles may be added to the porous layer in such an amount (for example, 10% by weight or less based on the amount of the silica fine particles) that it does not inhibit glossiness or ink-absorption property thereof.

An amount of the silica fine particles contained in the porous layer is preferably 60% by weight or more, more preferably in the range of 65 to 95% by weight, particularly preferably in the range of 70 to 95% by weight based on the amount of the total solid content of the porous layer.

In the porous layer, a binder is preferably contained for the purpose of fixing the silica fine particles. As the binder, a hydrophilic binder having high transparency and capable of obtaining high permeability is preferred. For the use of the hydrophilic binder, it is important that the hydrophilic binder does not clog voids by swelling at the initial stage of permeation. From this point of view, a hydrophilic binder having low swellability at around room temperature is preferably used.

As the hydrophilic binder, polyvinyl alcohol, polyethylene glycol, starch, dextrin, carboxymethyl cellulose or the like, or a derivative thereof may be used, and a particularly preferred hydrophilic binder is completely or partially saponified polyvinyl alcohol or a cationically-modified polyvinyl alcohol. Among the polyvinyl alcohols, particularly preferred is a partially saponified polyvinyl alcohol having a saponification degree of 80% or more or a completely saponified polyvinyl alcohol, and an average polymerization degree thereof is preferably 500 to 5000.

Also, as the cationically-modified polyvinyl alcohol, there may be mentioned, for example, a polyvinyl alcohol having a primary to tertiary amino group or a quaternary ammonium group at the main chain or at the side chain thereof as disclosed in, for example, Japanese Unexamined Patent Publication No. Sho. 61-10483.

To maintain the void volume of the porous layer in the range of 15 to 50 ml/m², the binder is preferably contained in the range of 5 to 25% by weight based on the amount of the silica fine particles. A coated amount of the solid component of the silica fine particles is preferably in the range of 10 to 35 g/m², more preferably 13 to 30 g/m².

The porous layer of the present invention may be applied, if necessary, to a plural number of layers each containing different kinds of silica fine particles, agglomeration density, secondary particle size, binder formulation amount, kinds of additives, etc. As this time, the void volume is a sum of the void volumes of the plural number of layers as long as there is no specific hindrance such as permeation inhibition between the porous layers.

To the porous layer of the present invention, a cross-linking agent such as boric acid, etc., a water-soluble polyvalent metallic compound, a cationic polymer, an antioxidant, a radical inhibitor, and also, as a coating aid, a surfactant, water-soluble solvent, a thickener, a pH adjusting agent, and the like may be added for the purpose of preventing from cracking, improving fixing property of ink, improving preservability of an image and the like.

As the support to be used in the present invention, there may be used a plastic resin film made of a polyethylene, polypropylene, polyvinyl chloride, diacetate resin, triacetate resin, cellophane, acrylic resin, polyethylene terephthalate, polyethylene naphthalate and the like; non-water-absorptive support such as polyolefin resin coated paper, uncoated paper, art paper, coated paper, cast-coated paper, and the like. Of these, a non-water absorptive support is preferably used. Among the non-water absorptive support, a polyolefin resin coated paper is particularly preferred. A thickness of the support is preferably about 50 to about 250 μm.

When a non-water absorptive support such as a plastic resin film or a polyolefin resin coated paper is used as a support, a primer layer mainly comprising a natural polymer compound or a synthetic resin is preferably provided on the surface of the support on which the ink-receptive layer is to be provided. The primer layer provided on the support mainly comprises a natural polymer compound such as gelatin and casein, or a synthetic resin. Such a synthetic resin may include an acryl resin, a polyester resin, a vinylidene chloride resin, a vinyl chloride resin, a vinyl acetate resin, polystyrene, a polyamide resin, a polyurethane resin, etc. The primer layer is provided on the support with a thickness (dried thickness) in the range of 0.01 to 5 μm, preferably in the range of 0.01 to 2 μm.

To the support of the present invention, various kinds of back coating layer(s) may be provided for the purpose of providing writability, antistatic property, conveying property, anticurl property, etc. In the back coating layer, an inorganic antistatic agent, an organic antistatic agent, a hydrophilic binder, a latex, an anticuring agent, a pigment, a curing agent, a surfactant, etc. may be included in an optional combination.

When a coating solution for a porous layer is provided on a film support or a resin-coated paper support, it is preferred to carry out a corona discharge treatment, flame treatment, UV ray irradiation treatment, plasma treatment and the like prior to provision of the coating.

In the following, the present invention is explained in more detail by referring to Examples, but the present invention is not limited by these Examples. Incidentally, all “parts” and “%” mentioned below mean “parts by weight” and “% by weight” otherwise specifically mentioned, respectively.

### EXAMPLE 1

<Polyolefin Resin Coated Paper Support>

A bleached kraft pulp of hardwood (LBKP) was subjected to beating until it becomes 300 ml by the Canadian Standard Freeness to prepare a pulp slurry. To the slurry were added cationically modified starch in an amount of 1.5% based on the pulp, amphoteric polyacrylamide in an amount of 1.0% based on the same, alkyl ketene dimer in an amount of 0.2% based on the amount of the same as a sizing agent, and a polyamide polyamine epichlorohydrin in an amount of 0.2% based on the same, and the mixture was diluted with water to prepare a 1% slurry. This slurry was made paper by a tourdrinier paper machine while providing a suitable turbulence to have a basis weight of 170 g/m² and a density of 1.06 g/cm³ to prepare a base paper for a resin-coated paper.

While running the base paper, a wire surface thereof was subjected to corona discharge treatment, and a back coating for identification was carried out. Then, the wire surface was again subjected to corona discharge treatment, and a resin for back surface melted at 320° C. was subjected to extrusion coating in an amount of 20 g/m² to form a back resin layer with a rough surface shape. Next, a felt surface of the base paper was subjected to corona discharge treatment, and a resin for front surface melted at 320° C. was subjected to extrusion coating in an amount of 30 g/m² to form a front resin layer with a mirror surface shape. Moreover, the back resin surface was subjected to corona discharge treatment, and a back-coat coating solution for antistatic treatment was coated in an amount of 0.6 g/m² as a solid content and dried, then, the front resin surface was subjected to corona discharge treatment, and a solution for a subbing layer was coated in an amount of 50 g/m² as a solid content and dried, and wound up to prepare a polyolefin resin coated paper support.

<Formulation of Back Resin>

| | |
|---|---|
| Low density polyethylene | 30 parts |
| (Density: 0.920 g/cm³) | |
| High density polyethylene | 70 parts |
| (Density: 0.967 g/cm³) | |

<Formulation of Surface Resin>

| | |
|---|---|
| Master batch | 15 parts |
| (39.1 parts of low density polyethylene having a density of | |
| 0.918 g/cm³, 60 parts of anatase titanium oxide surface of | |
| which is coated in an amount of 0.8% by weight in terms of | |
| Al₂O₃, and 0.9 part of zinc stearate were mixed and kneaded | |
| by a Banbury mixer) | |
| Low density polyethylene | 85 parts |
| (density: 0.920 g/cm³) | |

<Formulation of Back Coating Solution>

| | |
|---|---|
| An alkali hydrolyzate of maleic anhydride polymer: 25% | 4 parts |
| solution | |
| Colloidal silica: 20% slurry | 20 parts |
| (SNOWTEX 20 available from Nissan Chemical Industries, | |
| Ltd.) | |
| Epoxy type crosslinking agent 10% solution | 1.5 parts |
| 2-Ethylhexyl sulfosuccinate: 5% solution | 0.5 part |
| The total amount was made up to 100 parts by water. | |

<Formulation of Subbing Solution>

| | |
|---|---|
| Lime-treated gelatin: 2% aqueous solution | 50 parts |
| 2-Ethylhexyl sulfosuccinate: 5% solution | 0.5 part |
| Chromium alum: 5% aqueous solution | 2 parts |
| The total amount was made up to 100 | |
| parts by water. | |

<Coating Solution 1 for Porous Layer>

| | |
|---|---|
| Fumed silica: 20% slurry | 70 parts |
| (Average primary particle size: 12 nm) | |
| Polydimethylallyl ammonium chloride: 10% aqueous solution | 2.8 parts |
| Boric acid: 10% aqueous solution | 4.2 parts |
| Polyvinyl alcohol: 10% aqueous solution | 21 parts |
| (Saponification degree: 88%, average polymerization degree: | |
| 3500) | |
| Surfactant: 5% aqueous solution | 0.84 part |
| The total amount was made up to 100 parts by water. | |

Further, an the coating solution for the inorganic fine particle-containing layer having the following formulation was coated on the porous layer by using a slot coater with a coating amount of wet components of 19 ml/m² and dried to obtain an ink-jet recording material of Example 1.

<Coating Solution 1 for Inorganic Fine Particle-Containing Layer>

| | |
|---|---|
| Colloidal silica: 20% slurry | 8 parts |
| (SNOWTEX O available from Nissan Chemical Co., Ltd.; | |
| average primary particle size: 15 nm, variation | |
| coefficient: 0.20) | |
| The total amount was made up to 100 parts by water. | |
| (Silica concentration: 1.6% by weight) | |
| A coated amount of the solid component of colloidal silica | |
| was 0.31 g/m². | |

### EXAMPLE 2

In the same manner as in Example 1 except for changing the coating solution 1 for the inorganic fine particle-containing layer of Example 1 to a coating solution 2 for the inorganic fine particle-containing layer, an ink-jet recording material of Example 2 was obtained.

<Coating Solution 2 for Inorganic Fine Particle-Containing Layer>

| | |
|---|---|
| Colloidal silica: 20% slurry | 6 parts |
| (SNOWTEX O available from Nissan Chemical Co., Ltd.) | |
| The total amount was made up to 100 parts by water. | |
| (Silica concentration: 1.2% by weight) | |
| A coated amount of the solid component of colloidal silica | |
| was 0.23 g/m². | |

### EXAMPLE 3

In the same manner as in Example 1 except for changing the coating solution 1 for the inorganic fine particle-containing layer of Example 1 to a coating solution 3 for the inorganic fine particle-containing layer, an ink-jet recording material of Example 3 was obtained.

<Coating Solution 3 for Inorganic Fine Particle-Containing Layer>

| | |
|---|---|
| colloidal silica: 20% slurry | 4 parts |
| (SNOWTEX O available from Nissan Chemical Co., Ltd.) | |
| The total amount was made up to 100 parts by water. | |
| (Silica concentration: 0.8% by weight) | |
| A coated amount of the solid component of colloidal silica | |
| was 0.15 g/m² | |

### COMPARATIVE EXAMPLE 1

In the same manner as in Example 1 except for changing the coating solution 1 for the inorganic fine particle-containing layer of Example 1 to a coating solution 4 for the inorganic fine particle-containing layer, an ink-jet recording material of Comparative example 1 was obtained.

<Coating Solution 4 for Inorganic Fine Particle-Containing Layer>

| | |
|---|---|
| Colloidal silica: 20% slurry | 20 parts |
| (SNOWTEX O available from Nissan Chemical Co., Ltd.) | |
| The total amount was made up to 100 parts by water. | |
| (Silica concentration: 4.0% by weight) | |
| A coated amount of the solid component of colloidal silica | |
| was 0.77 g/m². | |

### COMPARATIVE EXAMPLE 2

In the same manner as in Example 1 except for changing the coating solution 1 for the inorganic fine particle-containing layer of Example 1 to a coating solution 5 for the inorganic fine particle-containing layer, an ink-jet recording material of Comparative example 2 was obtained.

<Coating Solution 5 for Inorganic Fine Particle-Containing Layer>

| | |
|---|---|
| Colloidal silica: 20% slurry | 10 parts |
| (SNOWTEX O available from Nissan Chemical Co., Ltd.) | |
| The total amount was made up to 100 parts by water. | |
| (Silica concentration: 2.0% by weight) | |
| A coated amount of the solid component of colloidal silica | |
| was 0.38 g/m². | |

### EXAMPLE 4

In the same manner as in Example 2 except for changing the coating system of the coating solution for the inorganic fine particle-containing layer to the following method, an ink-jet recording material of Example 4 was obtained.

Coating was carried out by using a helical grooves-gravure rolls having a diameter of 60 mm, a helical grooves angle of 45°, line number of 90 lines/inch, and a depth of a groove of 110 microns with reverse rotation and kiss touch. A rotation number of the helical grooves-gravure rolls was regulated and coating was carried out with a coating amount of wet components of 20 ml/m², and drying was then carried out.

A coated amount of the solid component of colloidal silica was 0.24 g/m².

### EXAMPLE 5

In the same manner as in Example 4 except for coating the coating solution 3 for the inorganic fine particle-containing layer of Example 3 with the coating system of Example 4, an ink-jet recording material of Example 5 was obtained.

A coated amount of the solid component of colloidal silica was 0.16 g/m².

### EXAMPLE 6

In the same manner as in Example 4 except for coating the following coating solution 6 for the inorganic fine particle-containing layer with the coating system of Example 4 in a coating amount of wet components of 16 ml/m², an ink-jet recording material of Example 6 was obtained.

<Coating Solution 6 for Inorganic Fine Particle-Containing Layer>

| | |
|---|---|
| Colloidal silica: 20% slurry | 2.5 parts |
| (SNOWTEX O available from Nissan Chemical Co., Ltd.) | |
| The total amount was made up to 100 parts by water. | |
| (Silica concentration: 0.5% by weight) | |
| A coated amount of the solid component of colloidal silica | |
| was 0.08 g/m². | |

### COMPARATIVE EXAMPLE 3

In the same manner as in Example 4 except for coating the coating solution 4 for the inorganic fine particle-containing layer of Comparative example 1 with the coating system of Example 4, an ink-jet recording material of Comparative example 3 was obtained.

A coated amount of the solid component of colloidal silica was 0.82 g/m².

### COMPARATIVE EXAMPLE 4

In the same manner as in Example 4 except for coating the coating solution 5 for the inorganic fine particle-containing layer of Comparative example 2 with the coating system of Example 4, an ink-jet recording material of Comparative example 4 was obtained.

A coated amount of the solid component of colloidal silica was 0.40 g/m².

### EXAMPLE 7

In the same manner as in Example 4 except for coating the coating solution 7 for the inorganic fine particle-containing layer with the coating system of Example 4, an ink-jet recording material of Example 7 was obtained.

<Coating Solution 7 for Inorganic Fine Particle-Containing Layer>

| | |
|---|---|
| Colloidal silica: 20% slurry | 6 parts |
| (Quartron PL-3L available from Fuso Chemical Co., Ltd., | |
| average primary particle size: 35 nm, variation | |
| coefficient: 0.11) | |
| The total amount was made up to 100 parts by water. | |
| (Silica concentration: 1.2% by weight) | |
| A coated amount of the solid component of colloidal silica | |
| was 0.24 g/m². | |

### EXAMPLE 8

In the same manner as in Example 4 except for coating the following coating solution 8 for the inorganic fine particle-containing layer with the coating system of Example 4, an ink-jet recording material of Example 8 was obtained.

<Coating Solution 8 for Inorganic Fine Particle-Containing Layer>

| | |
|---|---|
| colloidal silica 20% slurry | 4 parts |
| (Quartron PL-3L available from Fuso Chemical Co., Ltd.) | |
| The total amount was made up to 100 parts by water. | |
| (Silica concentration: 0.8% by weight) | |
| A coated amount of the solid component of colloidal silica | |
| was 0.16 g/m². | |

### EXAMPLE 9

In the same manner as in Example 4 except for coating the following coating solution 9 for the inorganic fine particle-containing layer with the coating system of Example 4 in a coating amount of wet components of 16 ml/m², an ink-jet recording material of Example 9 was obtained.

<Coating Solution 9 for Inorganic Fine Particle-Containing Layer>

| | |
|---|---|
| Colloidal silica: 20% slurry | 2.5 parts |
| (Quartron PL-3L available from Fuso Chemical Co., Ltd.) | |
| The total amount was made up to 100 parts by water. | |
| (Silica concentration: 0.5% by weight) | |
| A coated amount of the solid component of colloidal silica | |
| was 0.08 g/m². | |

### EXAMPLE 10

In the same manner as in Example 4 except for coating the following coating solution 10 for the inorganic fine particle-containing layer with the with the coating system of Example 4, an ink-jet recording material of Example 10 was obtained.

<Coating Solution 10 for Inorganic Fine Particle-Containing Layer>

| | |
|---|---|
| Colloidal silica: 12% slurry | 10 parts |
| (Quartron PL-1 available from Fuso Chemical Co., Ltd., | |
| average primary particle size: 15 nm, variation coefficient: | |
| 0.14) | |
| The total amount was made up to 100 parts by water. | |
| (Silica concentration: 1.2% by weight) | |
| A coated amount of the solid component of colloidal silica | |
| was 0.24 g/m². | |

### EXAMPLE 11

In the same manner as in Example 4 except for coating the following coating solution 11 for the inorganic fine particle-containing layer with the coating system of Example 4, an ink-jet recording material of Example 11 was obtained.

<Coating Solution 11 for Inorganic Fine Particle-Containing Layer>

| | |
|---|---|
| Colloidal silica: 12% slurry | 6.7 parts |
| (Quartron PL-1 available from Fuso Chemical Co., Ltd.) | |
| The total amount was made up to 100 parts by water. | |
| (Silica concentration: 0.8% by weight) | |
| A coated amount of the solid component of colloidal | |
| silica was 0.16 g/m². | |

### EXAMPLE 12

In the same manner as in Example 4 except for coating the following coating solution 12 for the inorganic fine particle-containing layer with the coating system of Example 4 in a coating amount of wet components of 16 ml/m², an ink-jet recording material of Example 12 was obtained.

<Coating Solution 12 for Inorganic Fine Particle-Containing Layer>

| | |
|---|---|
| Colloidal silica: 12% slurry | 4.2 parts |
| (Quartron PL-1 available from Fuso Chemical Co., Ltd.) | |
| The total amount was made up to 100 parts by water. | |
| (Silica concentration: 0.5% by weight) | |
| A coated amount of the solid component of colloidal | |
| silica was 0.08 g/m². | |

### EXAMPLE 13

In the same manner as in Example 1 except for coating the coating solution 8 for the inorganic fine particle-containing layer of Example 8 with the coating system of Example 1, an ink-jet recording material of Example 13 was obtained.

A coated amount of the solid component of colloidal silica was 0.15 g/m².

### COMPARATIVE EXAMPLE 5

In the same manner as in Example 4 except for coating the following coating solution 13 for the inorganic fine particle-containing layer with the coating system of Example 4, an ink-jet recording material of Comparative example 5 was obtained.

<Coating Solution 13 for Inorganic Fine Particle-Containing Layer>

| | |
|---|---|
| Colloidal silica: 12% slurry | 33 parts |
| (Quartron PL-1 available from Fuso Chemical Co., Ltd.) | |
| The total amount was made up to 100 parts by water. | |
| (Silica concentration: 4.0% by weight) | |
| A coated amount of the solid component of colloidal | |
| silica was 0.82 g/m². | |

### COMPARATIVE EXAMPLE 6

In the same manner as in Example 1 except for coating the coating solutions for the porous layer and the inorganic fine particles-containing layer of Example 1 with a simultaneous multi-layer coating by a slide bead coater, a recording material of Comparative example 6 was obtained.

### COMPARATIVE EXAMPLE 7

A sample before coating the inorganic fine particles-containing layer of Example 1 was made an ink-jet recording material of Comparative example 7.

### EXAMPLE 14

In the same manner as in Example 1 except for changing the coating solution 1 for the porous layer of Example 1 to the following coating solution 2 for the porous layer, and changing the coating solution 1 for the inorganic fine particles-containing layer to the coating solution 3 for the inorganic fine particles-containing layer of Example 3, an ink-jet recording material of Example 14 was obtained. When the void volume of the porous layer was obtained by using the mercury porosimeter, it was 25 ml/m². An average secondary particle size of the silica fine particles was 150 nm.

<Coating Solution 2 for Porous Layer>

| | |
|---|---|
| Finely pulverized wet process silica: 30% slurry | 47 parts |
| (Nipsil LP, trade name, available from TOSOH SILICA | |
| CORPORATION; a slurry in which an agglomerated particle | |
| size of 15 μm was finely pulverized by beads mill until an | |
| average secondary particle size became 200 nm or less) | |
| Polydimethylallyl ammonium chloride: 10% aqueous solution | 2.8 parts |
| Boric acid: 10% aqueous solution | 4.2 parts |
| Polyvinyl alcohol: 10% aqueous solution | 21 parts |
| (Saponification degree: 88%, average polymerization degree: | |
| 3500) | |
| surfactant 5% aqueous solution | 0.84 part |
| The total amount was made up to 100 parts by water. | |
| A coated amount of the solid component of colloidal silica | |
| was 0.15 g/m² | |

### EXAMPLE 15

In the same manner as in Example 1 except for changing the coating solution 1 for the porous layer of Example 1 to the following coating solution 3 for the porous layer, and changing the coating solution 1 for the inorganic fine particle-containing layer to the coating solution 3 for the inorganic fine particle-containing layer of Example 3, an ink-jet recording material of Example 15 was obtained. When the void volume of the porous layer was obtained by using the mercury porosimeter, it was 27 ml/m².

<Coating Solution 3 for Porous Layer>

| | |
|---|---|
| Finely pulverized wet process silica: 30% slurry | 24 parts |
| Fumed silica: 20% slurry | 35 parts |
| Polydimethylallyl ammonium chloride: 10% aqueous solution | 2.8 parts |
| Boric acid: 10% aqueous solution | 4.2 parts |
| Polyvinyl alcohol: 10% aqueous solution | 21 parts |
| (Saponification degree 88%, average polymerization degree | |
| 3500) | |
| Surfactant: 5% aqueous solution | 0.84 part |
| The total amount was made up to 100 parts by water. | |
| A coated amount of the solid component of colloidal silica | |
| was 0.15 g/m² | |

### EXAMPLE 16

In the same manner as in Example 4 except for coating the following coating solution 14 for the inorganic fine particle-containing layer with the coating system of Example 4 in a coating amount of wet components 16 ml/m², an ink-jet recording material of Example 16 was obtained.

<Coating Solution 14 for Inorganic Fine Particle-Containing Layer>

| | |
|---|---|
| Ultrafine particle zinc oxide: 5% slurry | 10 parts |
| (FZO-50, trade name, available from | |
| Ishihara Sangyo Kaisha Ltd., | |
| average primary particle size: 35 nm) | |
| The total amount was made up to 100 | |
| parts by water. | |
| (Concentration of zinc oxide: 0.5% by weight) | |
| A coated amount of the solid content of zinc oxide | |
| was 0.08 g/m². | |

### EXAMPLE 17

In the same manner as in Example 4 except for coating the following coating solution 15 for the inorganic fine particle-containing layer with the coating system of Example 4 in a coating amount of wet components of 16 ml/m², an ink-jet recording material of Example 17 was obtained.

<Coating Solution 15 for Inorganic Fine Particle-Containing Layer>

| | |
|---|---|
| Ultrafine particle antimony pentoxide: 48% slurry | 1 part |
| (A-2550, available from Nissan Chemical | |
| Industries, Ltd., average primary | |
| particle size: 40 nm) | |
| The total amount was made up to 100 | |
| parts by water. | |
| (Concentration of antimony pentoxide: | |
| 0.48% by weight) | |
| A coated amount of the solid content of | |
| antimony pentoxide was 0.08 g/m². | |

### EXAMPLE 18

In the same manner as in Example 4 except for coating the following coating solution 16 for the inorganic fine particle-containing layer with the coating system of Example 4 in a coating amount of wet components of 16 ml/m², an ink-jet recording material of Example 18 was obtained.

<Coating Solution 16 for Inorganic Fine Particle-Containing Layer>

| | |
|---|---|
| Zinc antimonate 31.6% slurry | 1.6 parts |
| (Z330H, available from Nissan | |
| Chemical Industries, Ltd., | |
| average primary particle size: 20 nm) | |
| The total amount was made up to 100 | |
| parts by water. | |
| (Concentration of zinc antimonate: | |
| 0.51% by weight) | |
| A coated amount of the solid content | |
| of antimony pentoxide was 0.08 g/m². | |

### EXAMPLE 19

In the same manner as in Example 4 except for coating the following coating solution 17 for the inorganic fine particle-containing layer with the coating system of Example 4 in a coating amount of wet components of 16 ml/m², an ink-jet recording material of Example 19 was obtained.

<Coating Solution 17 for Inorganic Fine Particle-Containing Layer>

| | |
|---|---|
| Cerium oxide: 10% slurry | 2 parts |
| (Neadral P10, trade name, | |
| available from Taki Chemical, | |
| K.K., average primary particle size: 8 nm) | |
| The total amount was made up to 100 | |
| parts by water. | |
| (Cerium oxide concentration: 0.2% | |
| by weight) | |
| A coated amount of the solid component | |
| of cerium oxide was 0.03 g/m². | |

Incidentally, a viscosity of the coating solution for the inorganic fine particle-containing layer at 35° C. in the above-mentioned Examples and Comparative examples was each 1 to 3 mPa.S.

The ink-jet recording materials obtained as mentioned above were subjected to the following evaluations under sealed packaging after lapse of 24 hours at 50° C. The results are shown in Table 1.

<Ink-Absorption Property>

An ink-jet recording material was moisture-conditioned at 23° C., and a humidity of 55% RH (relative humidity) over day and night, and under the same conditions, the material was black-solid printed using an ink jet printer MJ-800C manufactured by Seiko Epson K.K., a PPC paper was overlapped on the printed surface by changing an interval of overlapping time and slightly pressed, and peeled off to evaluate back transcription of ink to the PPC paper.

\mathring{o}; Completely no back transcription after 20 seconds.

◯; There is a slight back transcription after 20 seconds, but completely no back transcription after 25 seconds.

Δ; There is a slight back transcription after 25 seconds, but completely no back transcription after 30 seconds.

X; There is back transcription even after 30 seconds.

<Glossiness>

Glossiness at the portion not printed of the ink-jet recording material was evaluated with naked eyes.

◯; Extremely good as the same with printing paper for photography.

Δ; Good with the same level as art paper or coated paper.

X; Markedly poor near to matte paper.

<Interference Fringe>

While changing an observation angle of the ink-jet recording material, appearance of an interference fringe was classified.

\mathring{o}; No interference fringe was observed.

◯; By sufficiently slanted, and interference fringe was checked, it could be sometimes found out.

Δ; Generally it was not observed, but when the material was markedly slanted, interference fringe could be sometimes found out.

X; Interference fringe could be found out in the range of usual observation angles.

<Disorder of the Coated Surface >

Presence or absence of disorder on appearance was observed.

TABLE 1

| | Ink | | | Disorder |
|---|---|---|---|---|
| Recording | absorption | | Interference | of coated |
| material | property | Glossiness | fringe | surface |
| Example 1 | ◯ | ◯ | ◯ to Δ | None |
| Example 2 | ◯ to ⊚ | ◯ | ◯ | None |
| Example 3 | ⊚ | ◯ | ◯ | None |
| Comparative | Δ | ◯ | X | None |
| example 1 | | | | |
| Comparative | Δ | ◯ | X | None |
| example 2 | | | | |
| Example 4 | ◯ to ⊚ | ◯ | ◯ | None |
| Example 5 | ⊚ | ◯ | ◯ | None |
| Example 6 | ⊚ | ◯ | ⊚ | None |
| Comparative | Δ | ◯ | X | None |
| example 3 | | | | |
| Comparative | Δ | ◯ | X | None |
| example 4 | | | | |
| Example 7 | ◯ to ⊚ | ◯ | ◯ | None |
| Example 8 | ⊚ | ◯ | ◯ | None |
| Example 9 | ⊚ | ◯ | ⊚ | None |
| Example 10 | ◯ to ⊚ | ◯ | ◯ | None |
| Example 11 | ⊚ | ◯ | ◯ | None |
| Example 12 | ⊚ | ◯ | ⊚ | None |
| Example 13 | ⊚ | ◯ | ◯ | None |
| Comparative | Δ | ◯ | X | None |
| example 5 | | | | |
| Comparative | Δ | Δ | — | Present |
| example 6 | | | | |
| Comparative | ⊚ | Δ | ⊚ | None |
| example 7 | | | | |
| Example 14 | ◯ to ⊚ | ◯ | ◯ | None |
| Example 15 | ◯ to ⊚ | ◯ | ◯ | None |
| Example 16 | ⊚ | ◯ | ⊚ | None |
| Example 17 | ⊚ | ◯ | ⊚ | None |
| Example 18 | ⊚ | ◯ | ⊚ | None |
| Example 19 | ⊚ | ◯ | ⊚ | None |

In the table, ”—” means that interference fringe cannot be evaluated since there is disorder on the coated surface.

In the table, “-” means that interference fringe cannot be evaluated since there is disorder on the coated surface.

As can be seen from the above-mentioned Examples, the present invention is excellent in ink-absorption property and glossiness, and interference fringe and disorder of the coated surface can be prevented. A coated amount of the solid component of the inorganic fine particles in the inorganic fine particles-containing layer is preferably 0.25 g/m²or less, more preferably 0.17 g/m² or less in the view point of ink-absorption property. Also, in the view point of preventing from interference fringe, it is preferably 0.25 g/m²or less, more preferably 0.1 g/m² or less.

Also, a coating amount of wet components in the inorganic fine particles-containing layer is preferably 90% by volume or less, more preferably 80% by volume or less based on the void volume of the porous layer. Moreover, for coating the inorganic fine particles-containing layer, a pre-metered coating methods such as a slot coater and a helical grooves-gravure rolls is preferably used.

In Comparative examples in which a coated amount of the solid component of the inorganic fine particles in the inorganic fine particles-containing layer exceeds 0.33 g/m², they are each inferior in ink-absorption property, and generate interference fringe.

Also, in Comparative example in which the porous layer and the inorganic fine particles-containing layer are subjected to simultaneous multi-layer coating, disorder occurred on the coated surface, and both of glossiness and ink-absorption property were insufficient.

1. A method for preparing an ink-jet recording material comprising the steps of
forming at least one porous layer containing silica particles with an average secondary particle size of 500 nm or less, and
coating a coating solution for preparing an inorganic particles-containing layer so that a solid content of the coated inorganic particles became 0.33 g/m² or less on the porous layer.

2. The method for preparing an ink-jet recording material according to claim 1, wherein a coating amount of wet components of the coating solution for the inorganic particles-containing layer is 90% by volume or less of a void volume of the porous layer.

3. The method for preparing an ink-jet recording material according to claim 1, wherein a coating system used for coating the coating solution of the inorganic particles-containing layer is a pre-metered coating method in which an amount of the coating solution is previously metered to a predetermined coating amount.

4. The method for preparing an ink-jet recording material according to claim 3, wherein a coating device used for the pre-metered coating method is a coating device having slits to flow out uniformly to a coating width direction, or a coating device using helical grooves gravure rollers each having a diameter of 100 mm or less.

5. The method for preparing an ink-jet recording material according to claim 1, wherein a viscosity at 35° C. of the coating solution for the inorganic particles-containing layer is 5 mPa.s or less.

6. The method for preparing an ink-jet recording material according to claim 1, wherein a void volume of the porous layer is 15 to 50 ml/m².

7. The method for preparing an ink-jet recording material according to claim 1, wherein the silica particles having an average secondary particle size of 500 nm or less contained in the porous layer is fumed silica or wet process silica pulverized, or a mixture thereof.

8. The method for preparing an ink-jet recording material according to claim 1, wherein the porous layer further contains a hydrophilic binder, and a content of the hydrophilic binder to the silica particles is 5 to 25% by weight.

9. The method for preparing an ink-jet recording material according to claim 1, wherein the inorganic particles contained in the inorganic particles-containing layer is colloidal silica or particles having an refractive index of 1.6 or more.

10. The method for preparing an ink-jet recording material according to claim 9, wherein an average primary particle size of the colloidal silica is 80 nm or less.

11. The method for preparing an ink-jet recording material according to claim 9, wherein the colloidal silica is monodispersed colloidal silica having an average primary particle size of 80 nm or less and a variation coefficient of 0.15 or less.

12. The method for preparing an ink-jet recording material according to claim 1, wherein inorganic particles-containing layer contains no hydrophilic binder, or contains a hydrophilic binder in an amount of not more than 5% by weight based on the amount of the inorganic particles.

13. The method for preparing an ink-jet recording material according to claim 1, wherein the support is a non-water absorptive support.

14. The method for preparing an ink-jet recording material according to claim 13, wherein the non-water absorptive support is a polyolefin resin coated paper.
